(19) United States
(12) Patent Application Publication
(10) Pub. No.: US 2026/0295597 A1
(43) Pub. Date: Oct. 1, 2026

(54) APPARATUS FOR DESTROYING ELECTRONIC DATA AND PROVIDING SELECTIVE STORAGE

(71) Applicant: Phiston Technologies, Inc., Miramar, FL (US)

(72) Inventors: M. Ali Ebadian, Miramar, FL (US); Raul Travieso, Miramar, FL (US); Alejandro Paya, Miramar, FL (US)

(21) Appl. No.: 19/683,821

(22) Filed: May 21, 2026

Related U.S. Application Data
(63) Continuation-in-part of application No. 19/350,725, filed on Oct. 6, 2025.
Application No. 19/350,725 is a continuation-in-part of application No. 18/167,461, filed on Feb. 10, 2023, now abandoned.

(51) Int. Cl. B02C 18/22; B02C 18/14; B02C 18/16; B02C 18/24; B02C 23/10; B02C 23/14

(52) U.S. Cl. CPC B02C 18/2216; B02C 18/14; B02C 18/24; B02C 23/10; B02C 23/14; B02C 2018/147; B02C 2018/164

(57) ABSTRACT

An apparatus for destroying electronic data and enabling selective material recovery is provided. A first stage shreds electronic waste into particles no greater than 20 mm by 20 mm. A second stage separates metal from non-metal using a belt-driven magnetic separator in which a continuous belt carries the particles across a magnet assembly; metal is removed to a first bin. A third stage shears the remaining non-metal to particles no greater than 2 mm by 2 mm, which pass a screen into a second bin. In certain embodiments, a vibratory feed ramp meters flow to the belt separator, and dust collection may be provided by a vacuum system and, optionally, a cyclone separator coupled by gasketed clamps.

### PRIORITY CLAIM

In accordance with 37 C.F.R. 1.76, a claim of priority is included in an Application Data Sheet filed concurrently herewith. Accordingly, the present invention claims priority as a continuation-in-part of U.S. patent application Ser. No. 19/350,725 entitled “APPARATUS FOR DESTROYING ELECTRONIC DATA AND PROVIDING SELECTIVE STORAGE”, filed Oct. 6, 2025, which claims priority to U.S. patent application Ser. No. 18/167,461, entitled “APPARATUS FOR DESTROYING ELECTRONIC DATA AND PROVIDING SELECTIVE STORAGE”, filed Feb. 10, 2023. The contents of the above referenced applications are incorporated herein by reference in its entirety.

### RELATED PRIOR ART

This application is related to U.S. Pat. No. 11,389,805 issued Jul. 19, 2022 and entitled Method and Apparatus for HDD and Electronic Waste Disposal.

### FIELD OF THE INVENTION

This invention is related to the field of sensitive material destruction and, in particular, to apparatus for destroying electronic data and providing selective storage by separating particles and further shredding non-metal particles to less than 2 mm by 2 mm.

### BACKGROUND OF THE INVENTION

Sensitive information is commonly stored on hard disk drives “HDD”, solid state drives “SSD”, and the like devices used for storage of data. The storage devices are coupled to motherboards, switches, caddies, brackets and the like; components which may be difficult to separate when the storage device has to be replaced or otherwise disposed of. It is critical that all data disposed of is unrecoverable. Government loss of sensitive data can be catastrophic. Business loss of sensitive date can result in trade secret theft and business advantage over a competitor. Individual loss of sensitive data can result in identity theft. No matter how trivial the theft may appear, the resulting harm can be irreparable.

When the life of a data storage device has ended, ideally the memory unit is removed from service and physically destroyed to assure that the stored information cannot be retrieved. Various apparatuses exist wherein the stored digital data is electronically or physically destroyed upon removal of the data storage. The goal being to assure that any sensitive material on the disk has been rendered unusable.

Various data destroying apparatus are described in Applicant's prior patents such as U.S. Pat. No. 7,324,321 for a Degaussing Apparatus; U.S. Pat. No. 7,852,590 for a Solid State Memory Decommissioner; U.S. Pat. No. 8,064,183 for a Capacitor Based Bi-Directional Degaussing Apparatus; U.S. Pat. No. 8,794,559 for a Solid State Storage Device Crusher; U.S. Pat. No. 9,776,192 for a Comminuting Apparatus; U.S. Pat. No. 10,071,382 for a Solid State Drive Disintegrator; U.S. Pat. No. 10,242,699 for a Single Pulse Degaussing Device; and U.S. Pat. No. 10,657,345 for a Media Destruction Verification Apparatus.

Data storage devices can be changed out due to lack of capacity or speed, mechanical malfunction, or simply due to a computer hardware/software upgrade. However, it is not always practical to separate the data storage device from the underlying supporting components. It is not uncommon for the entire computer to be disposed of and, if the consumer is not cognizant of which storage device is to be removed, the data storage device may be discarded with all data readily accessible. While certain types of devices used to store electronic media is easily removed, switchboxes, solid state drives, and other devices that may employ flash memory may require absolute destruction to help ensure that meaningful data cannot be extracted from the disks. While one solution is to shred the HDD, the disposal of only the HDD does not address other flash memory storage. Waste created by support components such as high-capacity hard drives with brackets or sleds, heat resistant magnetic recording (HAMR), microwave assisted magnetic recording (MAMR), perpendicular magnetic recording (PMR), rack switches, switch boxes, spindles, and so forth may be untouched. For this reason, the proper way to destroy media would be to destroy the memory storage and all associated components. However, simply shredding material leads to a mixture of metal and plastic making the waste non-recyclable leading to yet another problem. The millions of electronic devices that are disposed of that are shredded result in contaminated waste. Those devices that are not shredded may include sensitive data that can be absconded with and will consume unnecessary air space in landfills. For instance, a desktop computer placed in a landfill will result in a large airspace within the cabinet that consumes valuable landfill. Removal of the HDD may protect certain sensitive material but any flash memory left with the computer remains accessible and may include additional sensitive material. Further, removal of an HDD from a laptop is difficult wherein an owner may simply dispose of the laptop in a landfill in hopes that a nefarious act will not take place. Simply shredding the electronic device results in unusable contaminated waste.

What is desired is an apparatus for destroying data storage devices and associated component by a three-stage process capable of reducing electronic waste to a particle size of less than 2 mm by 2 mm.

### SUMMARY OF THE INVENTION

Disclosed is an apparatus for destroying data-bearing electronic waste and rendering the output suitable for disposal and/or recycling. The apparatus employs three processing stages mounted on a support frame. A first stage comminutes incoming devices (e.g., HDDs, SSDs, boards, and associated hardware) into pieces no greater than about 20 mm by 20 mm. A second stage separates metal-containing pieces from non-metal pieces and directs separated fractions to respective collection bins. In certain embodiments, the second stage employs a drum-style magnetized roller with a scraper; in other embodiments, the second stage employs a belt-driven magnetic separator in which a continuous belt conveys comminuted pieces across a magnet assembly and a scraper and belt-cleaning brush remove attracted metal for discharge to a first collection bin. A third stage shears the remaining non-metal pieces to a particle size no greater than about 2 mm by 2 mm, which pass through a screen into a second collection bin.

The apparatus may include tuned flow controls, for example, a vibratory feed ramp set at about 35° at the inlet to the belt-driven separator, to maintain steady throughput and reduce bridging. Dust control can be provided by an onboard vacuum system with carbon and HEPA filtration and, in certain embodiments, by coupling the third-stage outlet to a cyclone separator via quick-release, gasketed clamps. Reliability under high-duty cycles can be improved by a redesigned gearbox and coupling assembly and, in some embodiments, a torque limiter interposed in the third-stage drive path. Flexible connectors and acoustic panels can further reduce structure-borne and airborne noise to suit office-adjacent or noise-limited environments.

An objective of the invention is to improve the prior art by providing a single apparatus having stages for shredding and separating of material wherein the apparatus destroys all media and separates the shredded particles for proper recycling to a particle size of less than 2 mm by 2 mm, and separate metal from non-metal particles.

Accordingly, it is an objective of the instant invention to provide shredding of HDD and magnetic data carriers to a security level of less than H7 per DIN 66399.

Another objective of the invention is to have a first stage cut to reduce all material to 20 mm by 20 mm or less, a second stage to separate metal based components such a brackets and spindles; and a third stage to have a fine cut particle size of 2 mm by 2 mm for final destruction. It is noted that metal materials would not carry data storage wherein 20 mm by 20 mm size is suitable.

It is a further objective of the instant invention to employ a magnetized roller in the second stage together with a scraper to separate metal material from the magnetized roller.

Yet still another objective of the invention is provide an apparatus for treating media storage devices and electronic waste for disposal having relatively dust free destruction at a rate of about 5-10 seconds per device.

Yet another objective of the invention is to teach the use of a rotor based shredder having blades attached to the rotor at a 2 degree slope, the slope gives the advantage of generating a composition cutting force that allows the blades to shear particles.

Still another objective of the invention is to eliminate the need disassemble media storage devices, saving time and labor costs.

Yet another objective of the invention is to provide a belt-driven architecture in place of a drum-style magnetic separator to improve separation efficiency, eliminating clogging, and stabilizing material throughput during operation.

A further objective of the invention is to incorporate tuned flow controls, including a modified ramp angle and vibratory feed, to maintain steady debris flow and prevent jamming between processing stages.

Another objective of the invention is to improve serviceability and dust control by providing quick-release, gasketed clamps in conjunction with an integrated cyclone separator.

Still another objective of the invention is to increase reliability through the use of a redesigned gearbox/coupling assembly and a torque limiter, reducing the likelihood of drivetrain failures during extended operation.

Yet another objective of the invention is to reduce operational noise levels by including flexible connectors and acoustic panels which allow the apparatus to be deployed in environments with stricter noise constraints.

Other objectives and advantages of this invention will become apparent from the following description taken in conjunction with any accompanying drawings wherein are set forth, by way of illustration and example, certain embodiments of this invention.

### BRIEF DESCRIPTION OF THE FIGURES

FIG. 1 is a front plane view of the HDD and electronic waste disposal apparatus of the instant invention with shielding in place;

FIG. 2 is a right side view thereof;

FIG. 3 is a cross-sectional view taken along lines A-A of FIG. 1;

FIG. 4 is a front perspective view of the magnetic roller;

FIG. 5 is a rear perspective view of the magnetic roller;

FIG. 6 is an exploded view of the HDD and electronic waste disposal apparatus with shielding removed and the bin carriage separated;

FIG. 7A is a perspective view of a first stage knife;

FIG. 7B is a side view of the first stage knife;

FIG. 7C is an edge view of the first stage knife;

FIG. 8A is a perspective view of a first stage spacer;

FIG. 8B is a side view of the first stage spacer;

FIG. 8C is an edge view of the first stage spacer;

FIG. 9A is a perspective view of the third stage mill;

FIG. 9B is a perspective view of the third stage mill with the cover removed;

FIG. 9C is a cross sectional front view of the third stage mill;

FIG. 9D is a perspective view of the third stage mill knife blades;

FIG. 9E is an enlarged view of a knife blade from FIG. 9D;

FIG. 9F is a cross-sectional side view of the third stage mill;

FIG. 10 is a front plane view of the HDD and electronic waste disposal apparatus of the instant invention having a belt-fed unit with tuned flow controls;

FIG. 11 is a front plane view thereof including a cyclone separator;

FIG. 12 is a right side view thereof;

FIG. 13 is a cross sectional view taken along lines A-A of FIG. 11;

FIG. 14 is a perspective view of the electronic waste disposal apparatus of the instant invention including the cyclone separator;

FIG. 15 is a perspective view of a belt-fed magnetic separator;

FIG. 16 is an exploded view of the HDD and electronic waste disposal apparatus with the belt-fed magnetic separator with shielding removed and the bin carriage separated; and

FIG. 17 is a rear perspective view thereof.

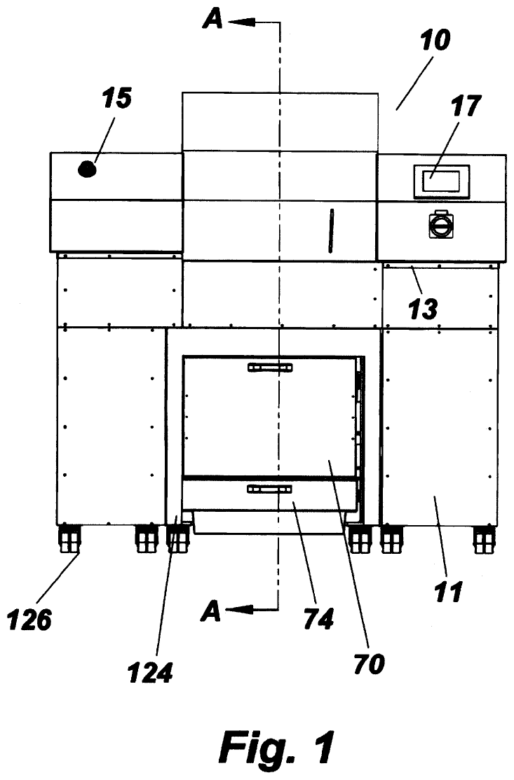

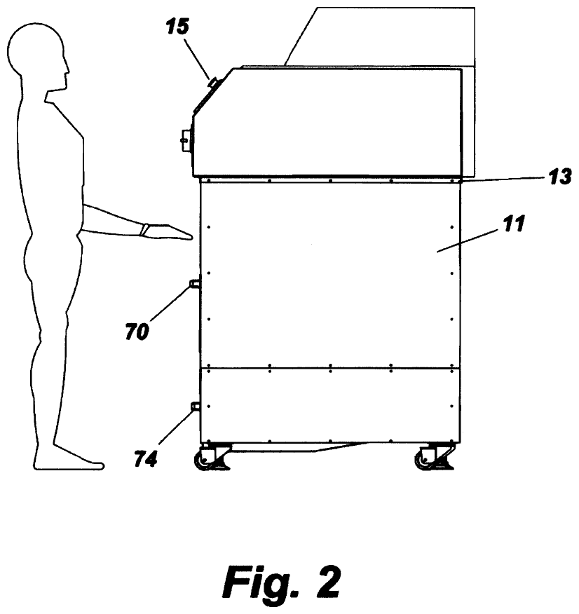

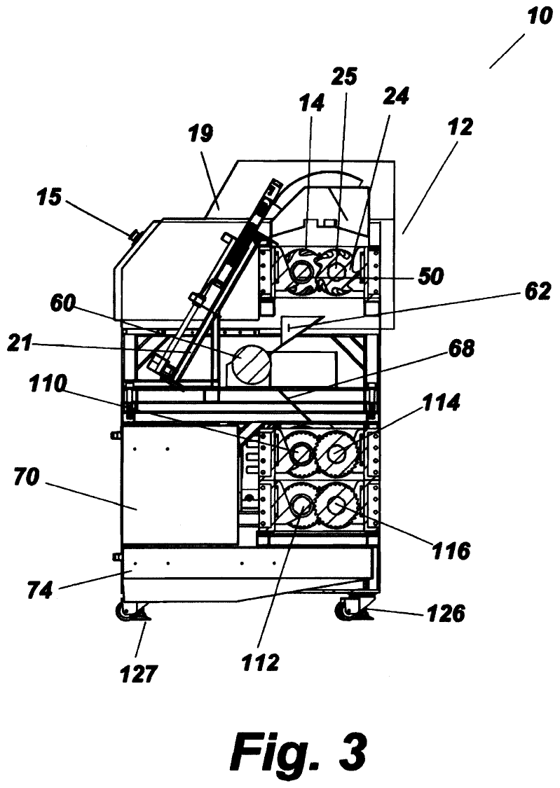

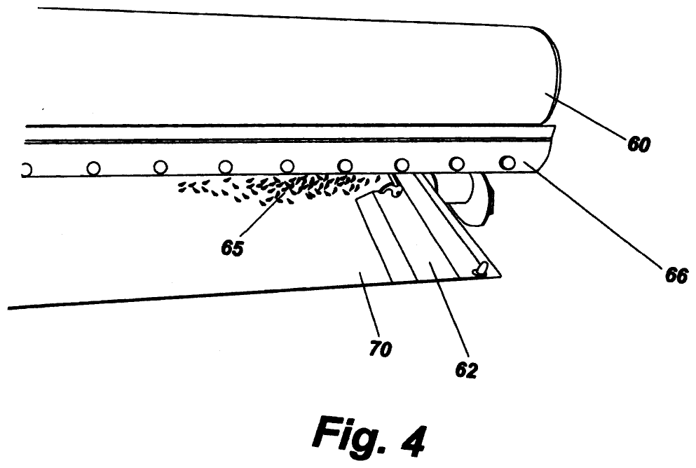

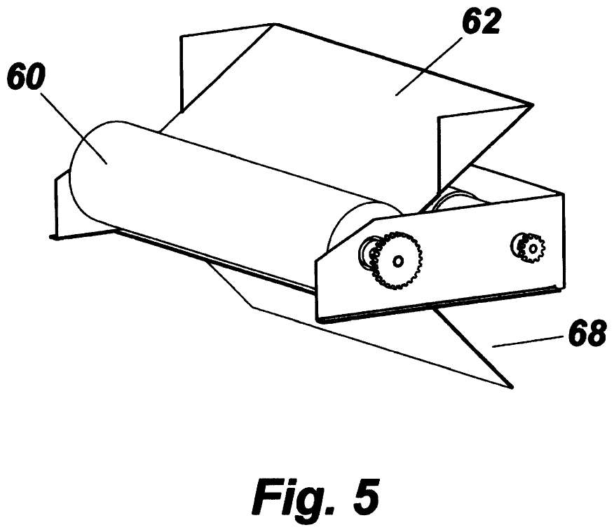

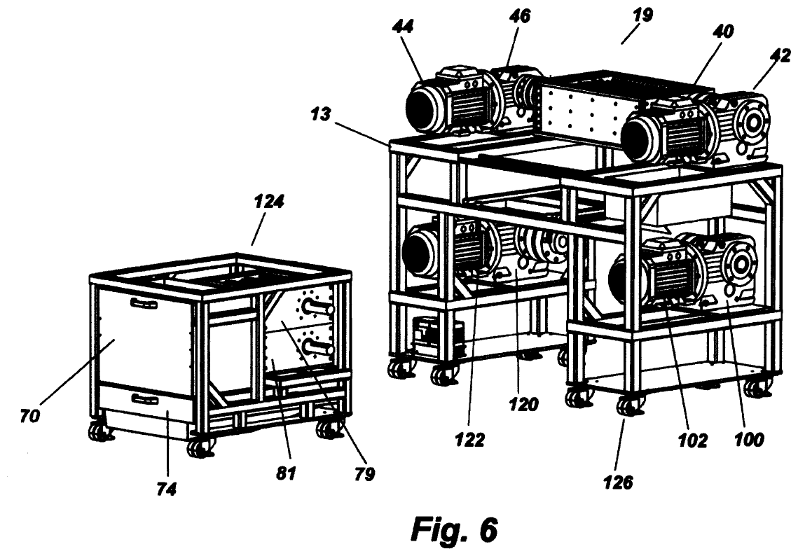

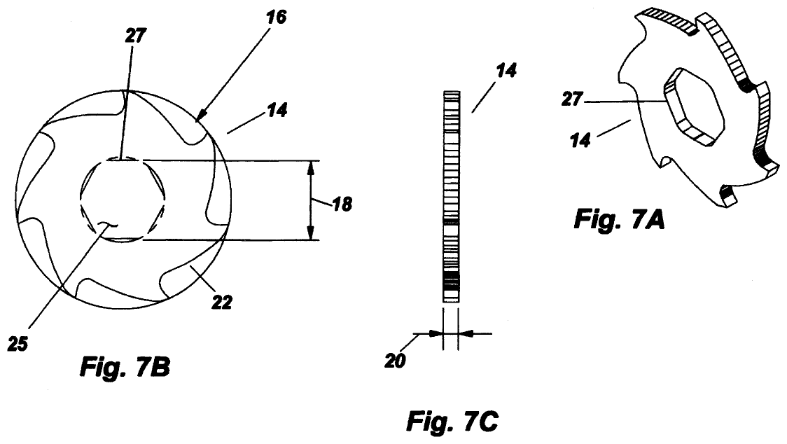

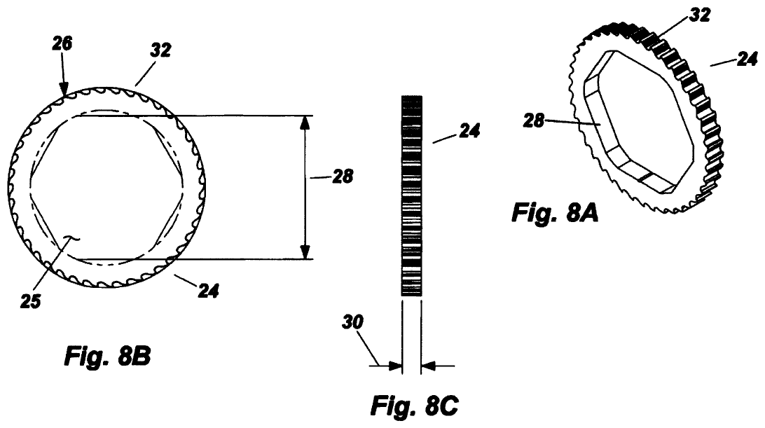

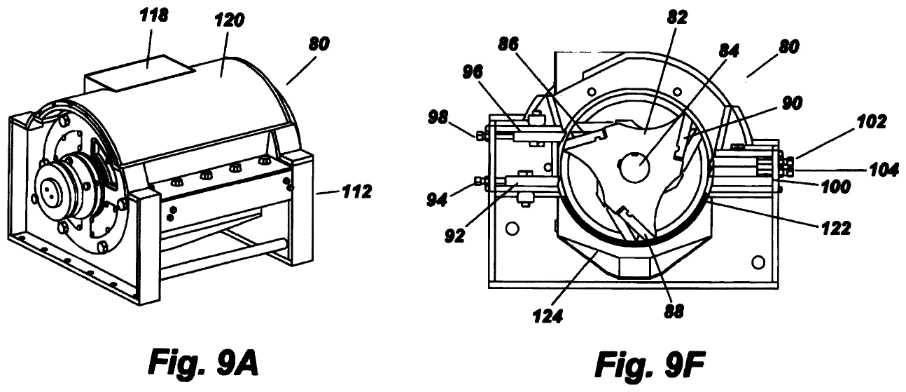

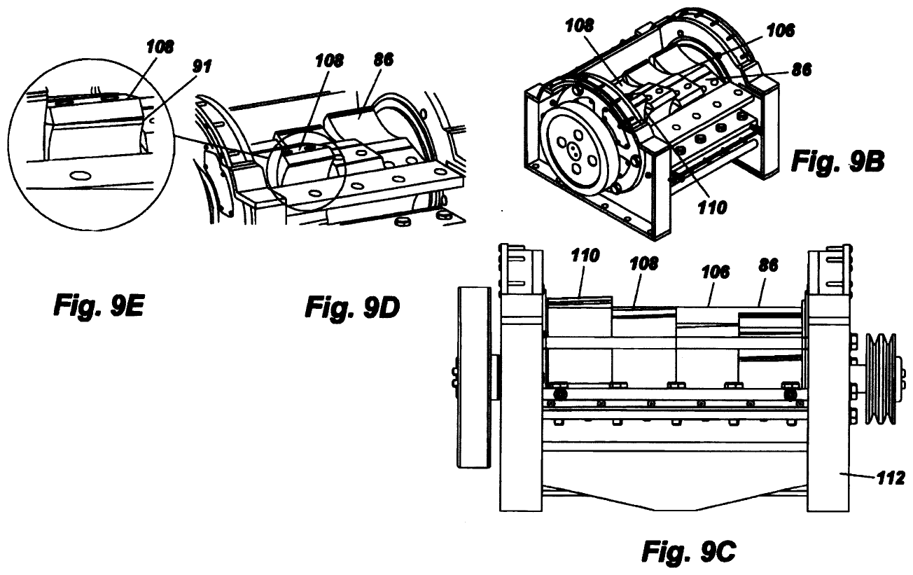

### DETAILED DESCRIPTION OF THE INVENTION

While the present invention is susceptible of embodiment in various forms, there is shown in the drawings and will hereinafter be described as presently preferred, albeit not limiting, embodiment with the understanding that the present disclosure is to be considered an exemplification of the present invention and is not intended to limit the invention to the specific embodiments illustrated.

Referring to the Figures in general, depicted is the electronic waste disposal apparatus 10 of the instant invention employing sound and protective shields 11 attached to a support frame (also referred to as a main frame) 13. Casters stabilize the apparatus; caster wheels 126 allow movement as necessary. A detachable frame 124 houses a first collection bin 70 and a second collection bin 74 for separated collection. The bins 70, 74 can be removed and emptied as needed. The detachable frame 124 can be pulled away from the support frame 13 for service of the bins or for access to the third-stage mill having a second shredder 80, as further explained. The front of the apparatus 10 includes an emergency shut-off 15 and a control panel 17.

A pre-feed hood 200 defines an enlarged feed opening sized to accept a range of data-bearing devices and associated electronic waste. In certain embodiments, a vibratory chute 61 is integrated at the inlet to maintain continuous flow to the first stage shredder 19 which mitigates bridging and clogging. The chute 61 may be coupled to the ramp surface 62 discussed below to present material in a controlled layer to downstream components. In some embodiments, the vibratory chute 61 is driven by a chute motor 63 that imparts vibration to the chute 61. The chute motor 63 may be controlled by a variable frequency drive (VFD) to adjust the level of vibration and regulate the flow of material through the chute 61.

The first stage shredder 19 includes a first shaft 25 having opposing flat surfaces 27 spaced apart 64.50 mm forming a hexagon shape. While a hexagon shape is preferred, it will be obvious to one skilled in the art that the shaft may be splined, or otherwise of a shape to assure positive transmission of torque from the shaft to the knives 14 and spacers 24. Each knife 14 preferably having seven scallops 22. Between each knife 14 is a spacer 24 having a 90 mm outer diameter 26, a 70 mm inner diameter 28 and an 8.80 width 30 with forty one teeth 32. The inner diameter 28 constructed and arranged to receive the shaft 25. A first electric motor 40 is coupled to a gearbox 42 to rotate the first shaft 25 in a clockwise direction. A second motor 44 is coupled to a second gearbox 46 to rotate a second shaft 50 in a counter-clockwise direction, or opposite direction of the first shaft 25. In particular, the second gearbox 46 rotates in a counter-clockwise direction with a plurality of reciprocal cutting knives and blades forming a mirror image of first set of knives and spacers forming an interlaced set of knives and spacers. For ease of clarity a single set of knives 14 and spacers 24 is depicted but it is understood that the clockwise rotation and counter-clockwise rotation is constructed and arranged to shred material passing between the teeth to particles no greater than 20 mm by 20 mm for the first stage.

The first stage directs shredded material to a second stage for drawing metal particles. The second stage comprises a magnetized roller 60 that receives shredded material that is funneled to the roller 60 by a ramp surface 62. A roller motor 64 rotates the roller 60 which is steel with an electro magnet causing metal particles to adhere to the roller. Metal particles 65 are removed from the roller 60 by a scraper 66, the metal particles directed to a first bin 70, non-metal particles that do not adhere to the roller are directed to a third stage by a directional chute 68. Metal particles include spindles, brackets, sleds and the like metal materials that are difficult to shred to a size less than 20 mm. Since metal particles do not store data, they do not need to be shredded further saving energy in the limited process. The scraper 66 is positioned adjacent to the roller 60 and used to scrape metal materials 65 as the roller 60 spins. The metal material removed from the roller 60 is directed to the first bin 70 and is available for recycling. The second stage eliminates the need to shred all materials to less than 2 mm as the second stage separates the metal from the electronic media holding element. This reduces the wear on the third stage and allows for the use of larger teeth to maintain fast component destruction. Items that benefit from treatment through the first stage in HDD, Enterprise HDD, cell/smart phones, PDA's, tablets, HDD hybrids including HAMR and MAMR, motherboards, switches, routers, PCIe/NVMe, and the like electronic waste. Items that benefit from treatment through the third stage in SSD's, Enterprise SSD's circuit boards, USB/flash drives, credit cards, CD/DVDs PDA's, SIM cards BLU-RAY and the like devices. Capacities allow for shredding at the rate of about 360 to 400 HDDs per hour (1 HDD every 10 seconds) based on standard form factor testing. Switches can be shredded at a rate of about 400/hr, HDD 360/hr, SSD 720/hr.

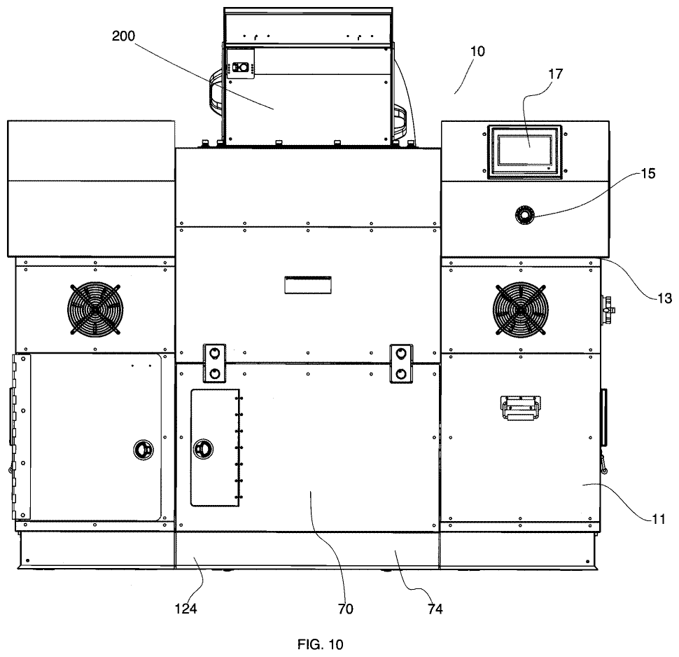

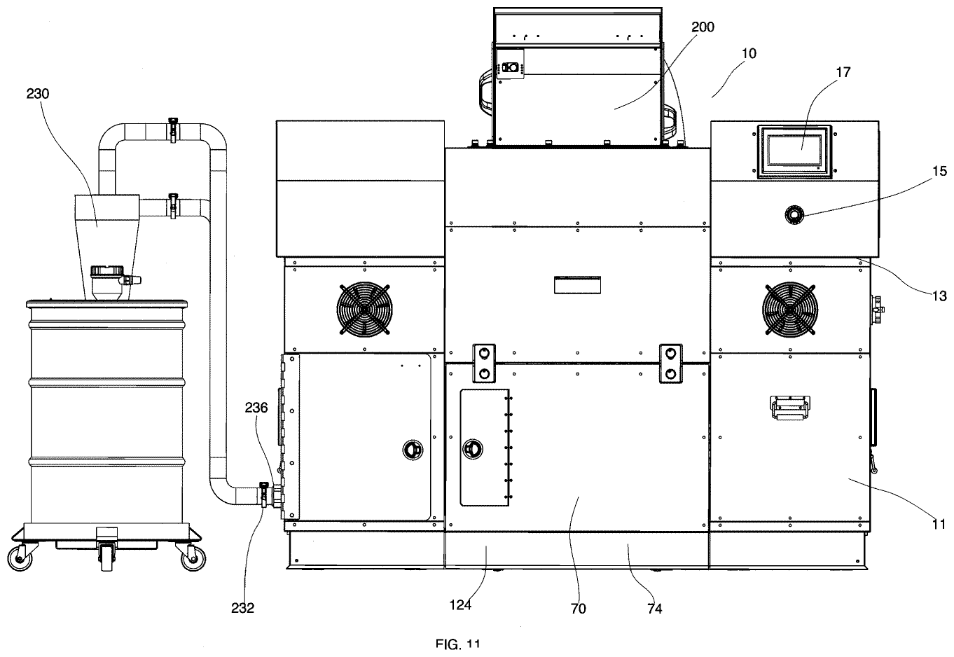

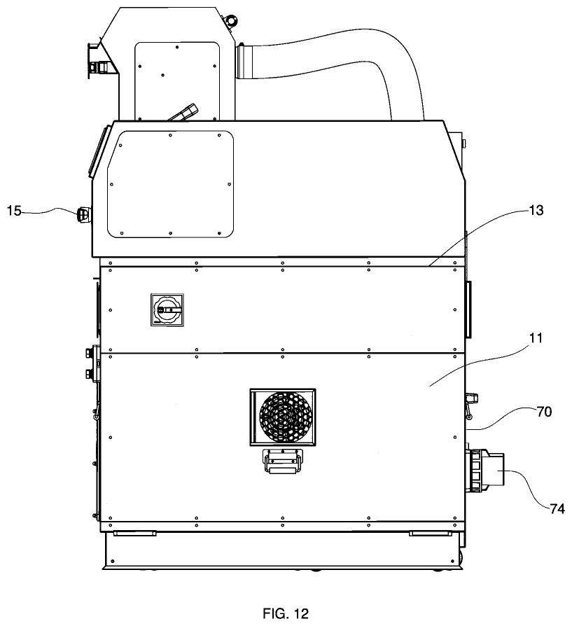

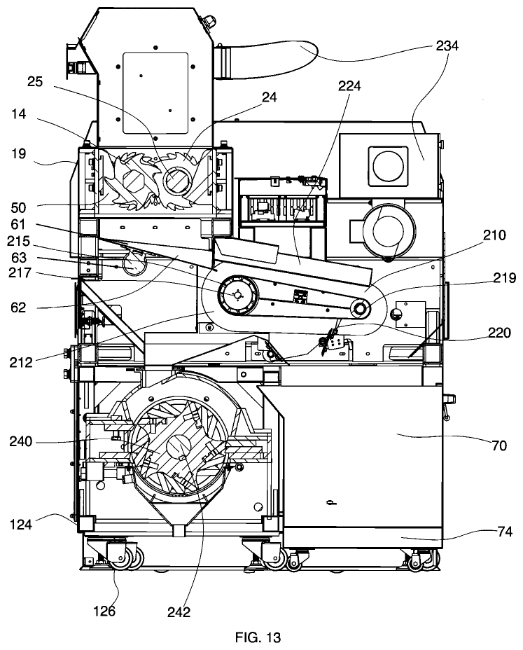

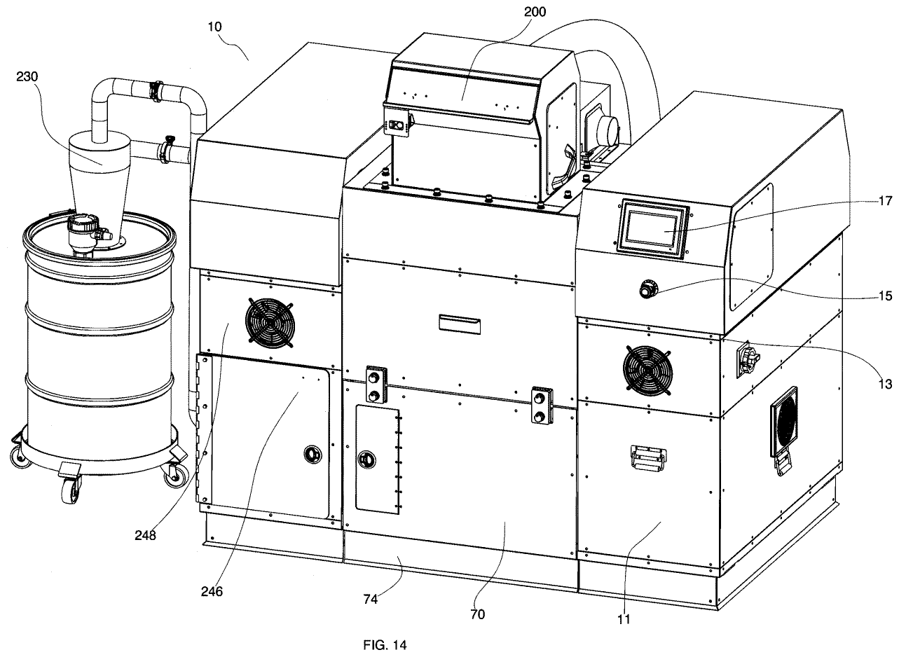

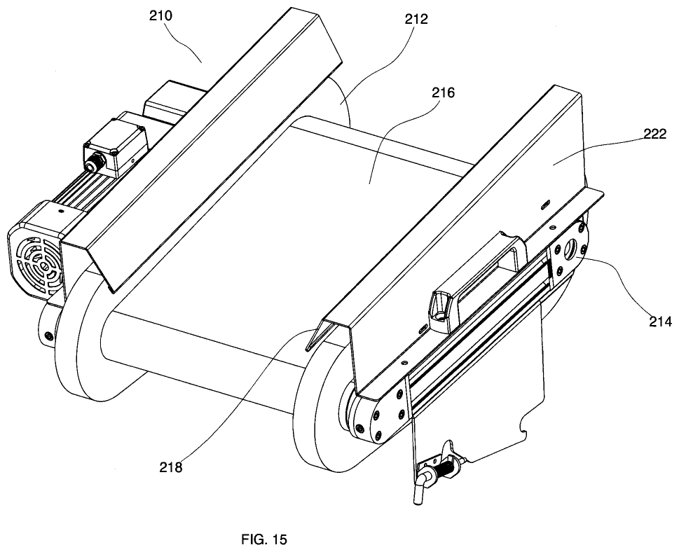

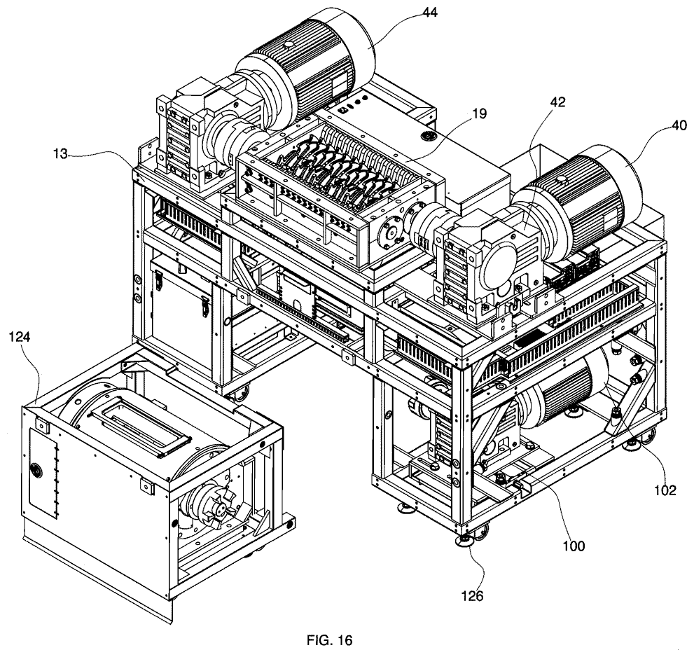

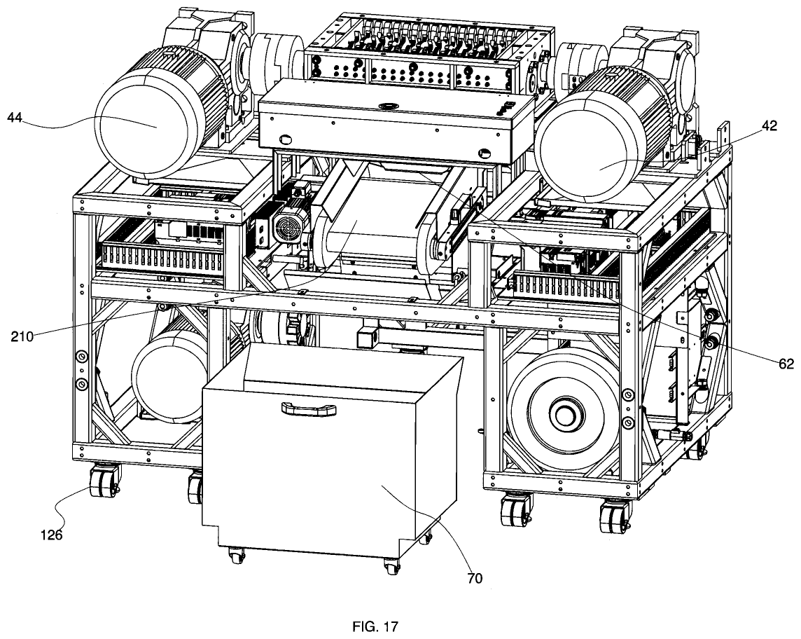

In another embodiment (FIGS. 10-17), the second stage employs a belt-driven magnetic separator 210 in place of the drum-style magnetic roller 60. A vibratory feed ramp 216, set at about 35°, meters shredded material from the first stage onto a continuous belt 212 that conveys the material across a magnet assembly 214. The belt 212 is trained about a drive roller 217 and an idler/tensioning roller 219, and a belt conveyor motor 215 operatively coupled to the drive roller 217 advances the belt to maintain continuous conveyance across the magnet assembly 214. Metal-containing pieces or particles are captured at the magnet assembly 214 and are removed from the belt by a scraper 218 and belt-cleaning brush 220 for discharge into the first bin 70. Side leak-prevention panels 222 laterally confine the conveyed stream, and a separator guard 224 inhibits flyback and cross-contamination between ferritic and non-ferritic fractions. This belt-fed architecture reduces clogging observed with drum configurations, stabilizes separation, and supports sustained throughput under high-duty cycles; integrated tests have shown approximately 15.3 s per HDD in magnetic-separator validation (including ferritic-bin bag changes) and approximately 29.5 s per drive across scaled workflows, these figures being exemplary and non-limiting.

A third stage involves shredding the non-metal particles received through the chute 68 into debris measuring no greater than 2 mm by 2 mm for collection in a second collection bin 74. In this embodiment a second shredder assembly 80 uses a scissor shearing effect by placing blades at a 2° slope. In particular the second shredder 80 employs a plurality of rotors 82 securable to a drive shaft 84. To lessen drawing confusion, a single rotor 82 will be enumerated but preferably four rotors are used as illustrated. In the preferred embodiment each rotor 82 has a first cutting blade 86, a second cutting blade 88, and a third cutting blade 90 attached thereto. Each cutting blade 86, 88, 90 is attached to the rotor 82 at a 2 degree slope depicted by number 91, the slope gives the advantage of generating a composition (2 directions due to the angle-tangent to the rotation and parallel to the axis of rotation) cutting force that allows the blades to shear the media particles. The shearing action increases cutting efficiency by minimizing energy loss through impact such as in the base of parallel blades. The rotational kinetic energy dissipated abruptly through impact is instead dissipated into shearing the particles with reduced rotor deceleration.

The cutting blades 86, 88, and 90 operate with the 2 degree slope in combination with a first bar blade 92 made adjustable using a threaded positioner 94. A second bar blade 96 is made adjustable using a threaded positioner 98 and parallel disposed bar blades 100 are made adjustable using threaded positioners 102, 104. Each rotor having an offset rotation allowing cutting blades 86, 106, 108, and 110 to cause the composite cutting force that allows the cutting blades to efficiently shear the media particles. Each said cutting blade is secured to a rotor by use of a threaded bolt to allow ease of service.

The second shredder includes a base 112 with a drive 114 configured to drive auxiliary belt-driven devices from a first end of the shaft 84, and a weighted coupler 116 secured to an opposite end of the shaft 84 for coupling to a drive motor. The coupler 116 is constructed and arranged to maintain a rotation speed during the shredding procedure. The base 112 includes an opening 118 for receipt of materials and a removable cover 120 for service. A screen 122 has 2 mm by 2 mm openings to assure particles passing into the collection bin 74 are 2 mm by 2 mm or less. An electric motor driver 93 is rotatably coupled to a third gearbox 95 through the weighted coupler 116.

For improved dust control and serviceability, the third-stage outlet 236 may be fluidly coupled to a cyclone separator 230 via gasketed clamps 232, the cyclone serving as a pre-separator to reduce filter loading of an onboard vacuum system 130 with carbon and HEPA filters. In certain installations, an ambient HEPA collector 234 is positioned adjacent the apparatus 10 to capture residual airborne particulate in the surrounding environment.

Reliability under high-duty cycles is improved by a redesigned gearbox 240 and coupling assembly 242 in the drive path, and in some embodiments, a torque limiter interposed between the drive motor and shredder shaft 84. Under overload conditions caused by jams or unexpected inclusions, the torque limiter disengages and decouples the drivetrain to prevent shearing of the gearbox 240 and coupling assembly 242. This design reduces unplanned downtime and extends service life.

To reduce sound emissions for dock and office-adjacent installations, flexible connectors 246 and acoustic panels 248 are mounted at vibration-transfer interfaces and along selected enclosure walls. The connectors de-tune structure-borne transmission, while the panels absorb airborne components, yielding measured or expected A-weighted reductions appropriate for noise-sensitive environments. These acoustic features enable the apparatus to be deployed in environments with stricter noise constraints, such as office-adjacent IT rooms or recycling facilities subject to occupational noise limits.

All patents and publications mentioned in this specification are indicative of the levels of those skilled in the art to which the invention pertains. It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An apparatus for destroying electronic data and providing selective storage comprising:
a support frame including a detachable frame housing a first collection bin and a second collection bin;
a first stage for inserting data storage devices into a first shredder mounted on said support frame, said first shredder comprising intermeshing counter-rotating cutter stacks on respective shafts, a first motor operatively coupled to a first gearbox and driving a first shaft in a first direction, and a second motor operatively coupled to a second gearbox and driving a second shaft in an opposite direction, said first shredder is constructed and arranged to grind data storage devices into particles no greater than 20 mm by 20 mm;
a second stage for removing metal-containing particles passed through said first shredder, said second stage comprising a vibratory chute driven by a chute motor configured to impart vibration thereto coupled to a ramp surface positioned beneath said first shredder, said ramp surface being configured to receive the metal-containing particles from said vibratory chute and direct the metal-containing particles toward a vibratory feed ramp configured to meter the metal-containing particles at an angle of about 35° onto a belt-driven magnetic separator mounted to said support frame and including a continuous belt trained about at least a drive roller and an idler roller, wherein a belt conveyor motor is operatively coupled to drive said drive roller to convey the metal-containing particles across a magnet assembly, said magnet assembly being configured to attract metal-containing particles and to discharge the attracted metal-containing particles toward said first collection bin, and wherein said second stage further comprises a scraper and a belt-cleaning brush arranged to remove the attracted metal-containing particles from said continuous belt and discharge said metal-containing particles toward said first collection bin;
a third stage mounted in said support frame for shearing non-metal particles comprising a second shredder having a support base with a plurality of adjustable bar blades, said support base including a plurality of rotors rotated by an electric motor driver having cutting blades removably coupled thereto, said cutting blades and said adjustable bar blades constructed and arranged to shear non-metal particles to a size of less than 2 mm by 2 mm; and
a screen mounted in said support frame allowing passage of shredded non-metal particles into said second collection bin;
wherein said first collection bin holds metal particles no greater than 20 mm by 20 mm and said second collection bin holds non-metal particles no greater than 2 mm by 2 mm.

2. The apparatus for destroying electronic data and providing selective storage of claim 1, wherein said second stage further comprises side leak-prevention panels flanking said belt and a separator guard to inhibit flyback and cross-contamination.

3. The apparatus for destroying electronic data and providing selective storage of claim 1, wherein said first stage comprises counter-rotating intermeshing cutter stacks each including knives and toothed spacers on respective shafts driven by respective gearboxes and motors, said first stage being configured to produce particles no greater than about 20 mm by 20 mm.

4. The apparatus for destroying electronic data and providing selective storage of claim 1, wherein said third stage comprises four rotors on a shredder shaft, each rotor carrying three circumferentially spaced cutting blades set at about a 2° slope relative to an axis of rotation.

5. The apparatus for destroying electronic data and providing selective storage of claim 4, wherein said rotors are mutually offset and said third stage further comprises adjustable bar blades positionable by threaded positioners to set a shearing clearance with said cutting blades.

6. The apparatus for destroying electronic data and providing selective storage of claim 1, wherein each of said cutting blades is removably fastened to a corresponding rotor.

7. The apparatus for destroying electronic data and providing selective storage of claim 1, further comprising a cyclone separator fluidly coupled to an outlet of said third stage by gasketed clamps, said cyclone separator being configured to reduce filter loading of a dust-collection system.

8. An apparatus for destroying electronic data and providing selective storage comprising:
a support frame including a detachable frame housing a first collection bin and a second collection bin;
a first stage for inserting data storage devices into a first shredder mounted on said support frame, said first shredder comprising intermeshing counter-rotating cutter stacks on respective shafts, a first motor operatively coupled to a first gearbox and driving a first shaft in a first direction, and a second motor operatively coupled to a second gearbox and driving a second shaft in an opposite direction, said first shredder is constructed and arranged to grind data storage devices into particles no greater than 20 mm by 20 mm;
a second stage for removing metal-containing particles passed through said first shredder, said second stage comprising a vibratory chute driven by a chute motor configured to impart vibration thereto coupled to a ramp surface positioned beneath said first shredder, said ramp surface being configured to receive the metal-containing particles from said vibratory chute and direct the metal-containing particles toward a vibratory feed ramp configured to meter the metal-containing particles at an angle of about 35° onto a belt-driven magnetic separator mounted to said support frame and including a continuous belt trained about at least a drive roller and an idler roller, wherein a belt conveyor motor is operatively coupled to drive said drive roller to convey the metal-containing particles across a magnet assembly, said magnet assembly being configured to attract metal-containing particles and to discharge the attracted metal-containing particles toward said first collection bin, and wherein said second stage further comprises a scraper and a belt-cleaning brush arranged to remove the attracted metal-containing particles from said continuous belt and discharge said metal-containing particles toward said first collection bin;
a third stage mounted in said support frame for shearing non-metal particles comprising a second shredder having a support base with a plurality of adjustable bar blades, said support base including a plurality of rotors rotated by an electric motor driver having cutting blades removably coupled thereto, said cutting blades and said adjustable bar blades constructed and arranged to shear non-metal particles to a size of less than 2 mm by 2 mm; and
a screen mounted in said support frame allowing passage of shredded non-metal particles into said second collection bin;
a cyclone separator fluidly coupled to an outlet of said third stage by gasketed clamps, said cyclone separator being configured to reduce filter loading of a dust-collection system;
wherein said first collection bin holds metal particles no greater than 20 mm by 20 mm and said second collection bin holds non-metal particles no greater than 2 mm by 2 mm.

9. The apparatus for destroying electronic data and providing selective storage of claim 8, wherein said second stage further comprises side leak-prevention panels flanking said belt and a separator guard to inhibit flyback and cross-contamination.

10. The apparatus for destroying electronic data and providing selective storage of claim 8, wherein said first stage comprises counter-rotating intermeshing cutter stacks each including knives and toothed spacers on respective shafts driven by respective gearboxes and motors, said first stage being configured to produce particles no greater than about 20 mm by 20 mm.

11. The apparatus for destroying electronic data and providing selective storage of claim 8, wherein said third stage comprises four rotors on a shredder shaft, each rotor carrying three circumferentially spaced cutting blades set at about a 2° slope relative to an axis of rotation.

12. The apparatus for destroying electronic data and providing selective storage of claim 11, wherein said rotors are mutually offset and said third stage further comprises adjustable bar blades positionable by threaded positioners to set a shearing clearance with said cutting blades.

13. The apparatus for destroying electronic data and providing selective storage of claim 8, wherein each of said cutting blades is removably fastened to a corresponding rotor.

14. The apparatus for destroying electronic data and providing selective storage of claim 8, further comprising a vacuum system fluidly coupled to said third stage to capture airborne particulate, said vacuum system comprising carbon and HEPA filtration, and an ambient HEPA collector positioned adjacent said apparatus.
